(19) United States
(12) Patent Application Publication
(10) Pub. No.: US 2024/0343284 A1
(43) Pub. Date: Oct. 17, 2024

(54) SHOPPING CART

(71) Applicant: The Radio Flyer Company, Chicago, IL (US)

(72) Inventors: Jason Fitzwater, Chicago, IL (US); Erin Rice, Chicago, IL (US); Collin Ostergaard, Chicago, IL (US)

(21) Appl. No.: 18/632,434

(22) Filed: Apr. 11, 2024

Related U.S. Application Data
(60) Provisional application No. 63/495,308, filed on Apr. 11, 2023.

(51) Int. Cl. B62B 3/02; A63H 5/00; A63H 33/30

(52) U.S. Cl. CPC B62B 3/02; A63H 5/00; A63H 33/30

(57) ABSTRACT

A shopping cart has a base, a basket that moves up and down, and a latching mechanism to secure the basket to the base in a variety of vertical positions. The base has wheels, and legs extending upwardly. The basket has receivers to receive the legs of the base. The latching mechanism has an activator, a bias member, and latching pins. The activator moves from a normal position to a biased position to move the latching pins from an engaged position to a disengaged position. The latching pins are removed from the openings in the legs when the activator is in the biased position, and the latching pins engage openings in the legs when the activator is in the normal positon to secure the basket at a variety of positions about the legs.

### CROSS-REFERENCE TO RELATED APPLICATIONS

This application claims the benefit of U.S. Provisional Patent Application No. 63/495,308 filed Apr. 11, 2023, which is expressly incorporated herein by reference and made a part hereof.

### FEDERALLY SPONSORED RESEARCH OR DEVELOPMENT

Not Applicable.

### TECHNICAL FIELD

The present subject matter relates to a shopping cart, and more particularly, to a shopping cart having a basket that raises and lowers.

### BACKGROUND

Shopping carts are known in the art. While such products according to the prior art provide a number of advantages, they nevertheless have certain limitations, especially when combined together. The present disclosure seeks to overcome certain of those limitations and other drawbacks of the prior art, and to provide new features not heretofore available. A full discussion of the features and advantages of the present disclosure is deferred to the following detailed description, which proceeds with reference to the accompanying drawings.

### SUMMARY

According to certain aspects of the present disclosure, the disclosed subject technology relates to shopping carts that have a basket that raises and lowers.

The disclosed technology further relates to a shopping cart comprising: a base having a plurality of wheels and a plurality of legs extending upwardly, the legs having a plurality of openings about a length of each leg; a basket having a front wall, a plurality of side walls, a rear wall, and a bottom wall to define a cavity, the cavity being adjacent a first end of the basket for supporting items place within the cavity of the basket, the basket having a second end opposite the first end, the basket further having a plurality of receivers at a bottom of the basket for receiving the legs of the base; and, a latching mechanism to secure the basket to the base, the latching mechanism being connected to the basket and comprising a housing, an activator and latching pins, the activator moving from a normal position to a biased position and having angled slots to adjust the latching pins to allow the basket to traverse up and down on the legs, the latching pins engaging the openings in the legs when the activator is in the normal positon to secure the basket at a variety of positions about the legs, and the latching pins being removed from the openings in the legs when the activator is in the biased position.

The disclosed technology further relates to a shopping cart comprising: a base having a plurality of wheels and a leg extending upwardly, the leg having openings about a length thereof; a basket having a cavity for supporting items therein, a receiver for receiving the leg of the base, and a handle for pushing the shopping cart, the handle being provided adjacent a second end of the basket; and, a latching mechanism to secure the basket to the base, the latching mechanism being connected to the basket and comprising an activator, a bias member, and a latching pin, the activator moving from a normal position to a biased position, the bias member biasing the activator from its biased position to its normal position, the latching pin moving from an engaged position when the activator is in the normal position, to a disengaged position when the activator is in the biased position, the latching pin engaging one of the openings in the leg when the activator is in the normal positon, and the latching pin being removed from the openings in the leg when the activator is in the biased position to secure the basket at a variety of positions about the leg.

The disclosed technology further relates to a shopping cart, comprising: a base having a plurality of wheels and a plurality of legs extending upwardly, the legs having a plurality of openings about a length of each leg; a basket having a cavity for supporting items therein, a plurality of receivers adjacent a second end of the basket for receiving the legs of the base, and a handle for pushing the shopping cart, the handle being provided adjacent the second end of the basket; and, a latching mechanism to secure the basket to the base, the latching mechanism being connected to the basket and comprising an activator, a bias member, and latching pins, the activator moving from a normal position to a biased position, the bias member biasing the activator from its biased position to its normal position, the latching pins moving from an engaged position when the activator is in the normal position, to a disengaged position when the activator is in the biased position, the latching pins engaging openings in the legs when the activator is in the normal positon, and the latching pins being removed from the openings in the legs when the activator is in the biased position to secure the basket at a variety of positions about the legs.

The disclosed technology further relates to a shopping cart, wherein the latching pins have a shaft portion and a cam portion, wherein the cam portion of the latching pins extends within the angled slots of the activator, and wherein the shaft portion of the latching pins translates laterally to be positioned within the openings in the legs of the base.

The disclosed technology further relates to a shopping cart, wherein the receivers are provided adjacent the second end of the basket.

The disclosed technology further relates to a shopping cart, wherein the legs have an interior side and an exterior side, and wherein the openings are on the interior side of the legs.

The disclosed technology further relates to a shopping cart, wherein the exterior side of one or more of the legs includes a recess to receive a follower of the basket.

The disclosed technology further relates to a shopping cart, wherein one of more of the legs has a stop that operates in cooperation with an internal protrusion of the basket to prevent the basket from being lifted off the base when the basket is fully telescoped up on the legs.

The disclosed technology further relates to a shopping cart, wherein the basket also has a handle for pushing the shopping cart, the handle being provided adjacent the second end of the basket.

The disclosed technology further relates to a shopping cart, wherein the latching mechanism further comprises a bias member to force the activator from its biased position to its normal position.

The disclosed technology further relates to a shopping cart, further comprising a product separator adjacent the second end of the basket.

The disclosed technology further relates to a shopping cart, wherein the product separator comprises plurality of different shaped openings.

The disclosed technology further relates to a shopping cart, further comprising a product sensor adjacent the second end of the basket.

The disclosed technology further relates to a shopping cart, further comprising a controller and a speaker in electrical communication with the product sensor.

The disclosed technology further relates to a shopping cart, wherein the latching mechanism is secured to a bottom of the basket.

The disclosed technology further relates to a shopping cart, wherein the activator has a handle for a user to move the activator to the biased position.

The disclosed technology further relates to a shopping cart, wherein the activator has angled slots to adjust the latching pins to allow the basket to traverse up and down on the legs.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To understand the present disclosure, it will now be described by way of example, with reference to the accompanying drawings in which embodiments of the disclosures are illustrated and, together with the descriptions below are incorporated in and constitute a part of this specification, and serve to explain the principles of the disclosure. In the drawings:

FIG. 1 is a front top perspective view of a shopping cart in a first use position, according to the present disclosure.

FIG. 2 is a partial front perspective view of a shopping cart, according to the present disclosure, having a product sensor.

FIG. 3 is a partial front perspective view of a shopping cart, according to the present disclosure, having a product separator.

FIG. 4 is rear perspective view of the shopping cart of FIG. 3, according to the present disclosure, showing a product receptacle.

FIG. 5 is a front top perspective view of the shopping cart of FIG. 1 in a second use position, according to the present disclosure.

FIG. 6 is a front top perspective view of the shopping cart of FIG. 1, with the basket of the shopping cart exploded off the base, according to the present disclosure.

FIG. 7 is an exploded perspective view of one embodiment of a latching mechanism for the shopping cart, according to the present disclosure.

FIG. 8 is a rear bottom perspective view of the shopping cart of FIG. 6, with the basket of the shopping cart exploded off the base, according to the present disclosure.

FIG. 9 is a cross sectional view of the latching mechanism of FIG. 7 for the shopping cart, according to the present disclosure, with the latching mechanism in a normal mode.

FIG. 10 is a cross sectional view of the latching mechanism of FIG. 7 for the shopping cart, according to the present disclosure, with the latching mechanism in a biased mode to allow for moving of the basket up and down on the legs of the base.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

While this disclosure is susceptible of embodiments in many different forms, there is shown in the drawings and will herein be described in detail preferred embodiments with the understanding that the present disclosure is to be considered as an exemplification of the principles of the disclosure and is not intended to limit the broad aspect of the disclosure to the embodiments illustrated. It should be noted that the features illustrated in the drawings are not necessarily drawn to scale, and features of one embodiment may be employed with other embodiments as one of ordinary skill in the relevant art would recognize, even if not explicitly stated herein. Further, descriptions of well-known components and processing techniques may be omitted so as to not unnecessarily obscure the embodiments of the present disclosure. The examples used herein are intended merely to facilitate an understanding of ways in which the present disclosure may be practiced and to further enable those of ordinary skill in the art to practice the embodiments of the present disclosure. Accordingly, the examples and embodiments herein should not be construed as limiting the scope of the present disclosure, which is defined solely by the appended claims and applicable law.

Generally, this disclosure describes several embodiments of shopping carts 10 that are arrangeable in a variety of different orientations, both alone and in combination, and which have a variety of different functionality. In one embodiment, the shopping cart 10 has a base 12, a basket 14 and a latching mechanism 16 to secure the basket 14 to the base 12. In one embodiment, the basket 14 is moveable upwardly and downwardly on legs 18 of the base 12 to accommodate users of different heights. In another embodiment, the shopping cart 10 has a product sensor 20. In yet another embodiment, the shopping cart 10 has a product separator 22.

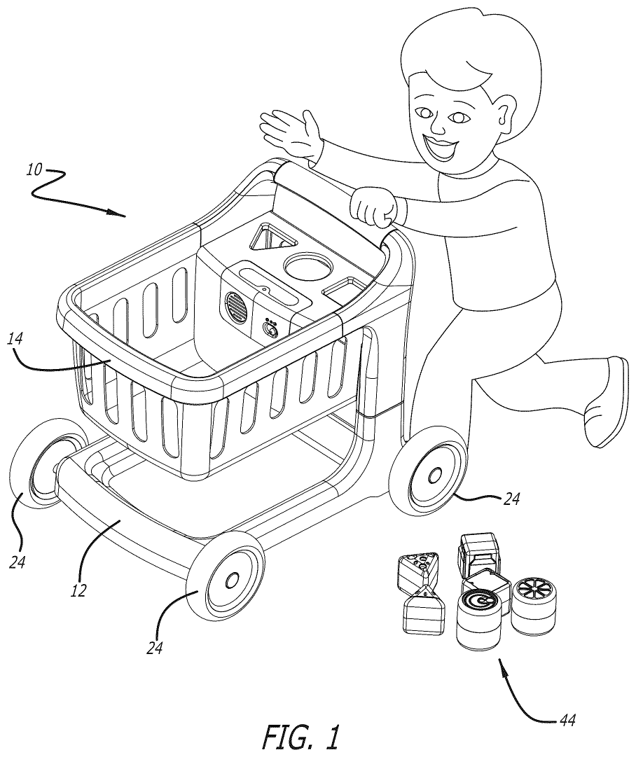

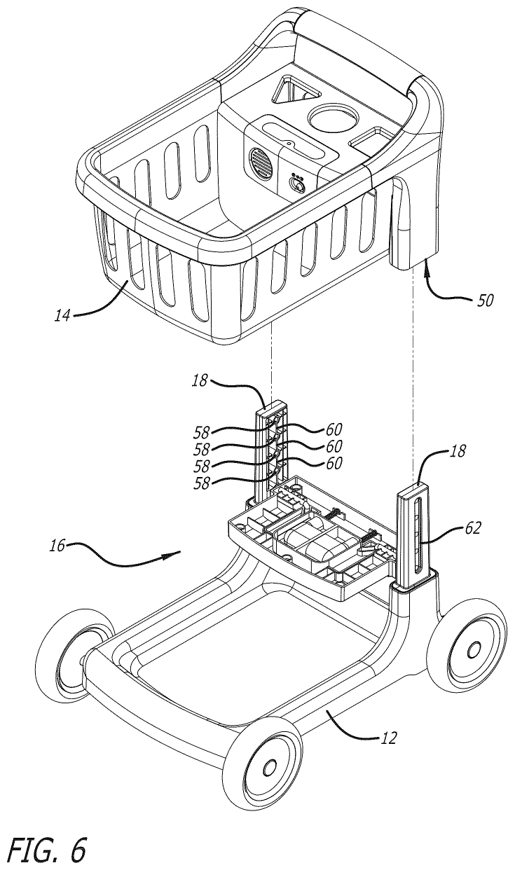

Referring now to the figures, and initially to FIGS. 1, 6 and 8, there is shown an embodiment of the shopping cart 10. The shopping cart 10 has a base 12 with a plurality of legs 18 and a plurality of wheels 24 to allow the shopping cart 10 to be moved and pushed about. The legs 18 extend upwardly from the base 12 and support the basket 14. In one embodiment, the basket 14 has a latching mechanism 16 that assists in securing the basket 14 to the legs 18 in a variety of vertical positions about the legs 18.

The basket 14 has a front wall 26, a plurality of side walls 28, a rear wall 30, and a bottom wall 32 to create a cavity 34 adjacent a first end 36 of the basket 14 for supporting items place within the cavity 34 of the basket 14. The basket 14 also has a handle 38 for pushing the shopping cart 10. In one embodiment, the handle 38 is provided at the second end 40 of the basket 14.

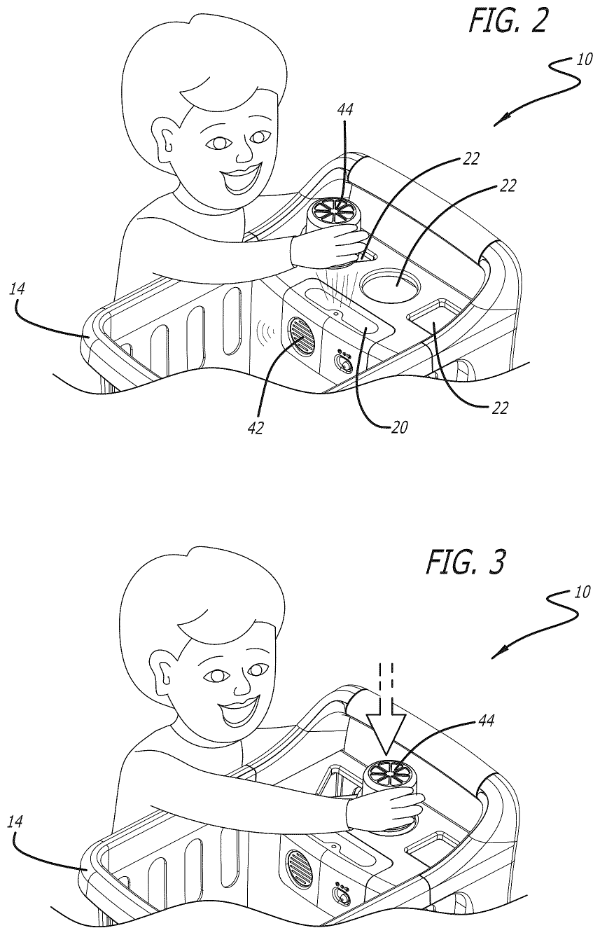

In one embodiment, the product sensor 20 is provided adjacent the second end 40 of the basket 14, and in an embodiment the product separator 22 is provided adjacent the second end 40 of the basket 14. The product sensor 20 may be any sensor that senses an object placed above the sensor 20. In one embodiment the sensor 20 may be an optical switch, proximity sensor, light sensor, photoelectric sensor, laser sensor, limit switch, etc. In one embodiment, the shopping cart 10 also has a controller (not shown) and a speaker 42. When the sensor 20 senses an object, such as one of the play food items 44 shown in FIG. 2, the controller operates the speaker 42 to state the name of the food item and/or the cost of the food item, etc. Typically, the controller operates the naming of the food item in a loop, such that it does not matter what play food item 44 is sensed for the controller to operate the speaker 42 to name the next food item in the loop.

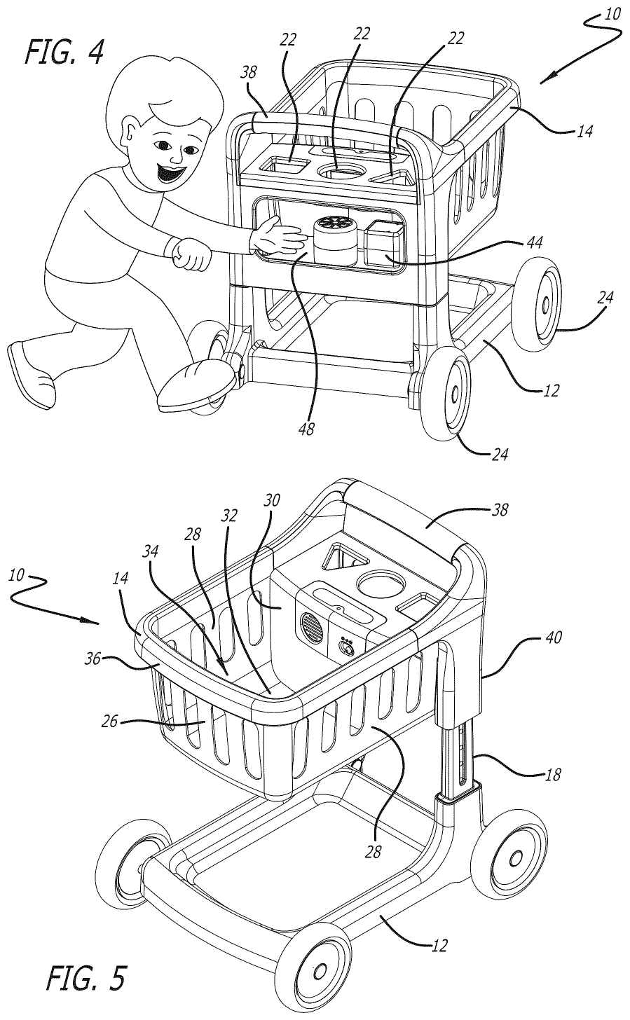

The different play food items 44 may have different shapes and sizes. Further, the product separator 22 may have a plurality of different shaped openings 46 that correspond to the different play food items 44. As shown in FIG. 4, the basket 14 also has a food compartment 48 open at the second end 40 of the basket 14 that stores the play food items 44 after they have passed through the product separator 22 food openings 46.

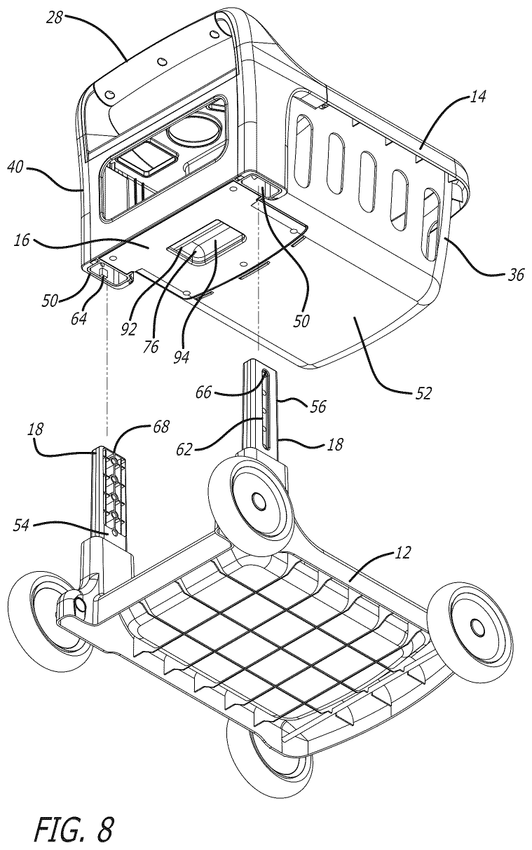

As shown in FIGS. 8-10, in one embodiment the basket 14 has a plurality of receivers 50 for receiving, respectively, the legs 18 of the base 12. In one embodiment, the receivers 50 are provided on the bottom 52 of the basket 14 adjacent the second end 40 of the basket 14. As shown in FIGS. 5-6 and 8-10, the legs 18 are inserted into the receivers 50 to retain the basket 14 on the base 12.

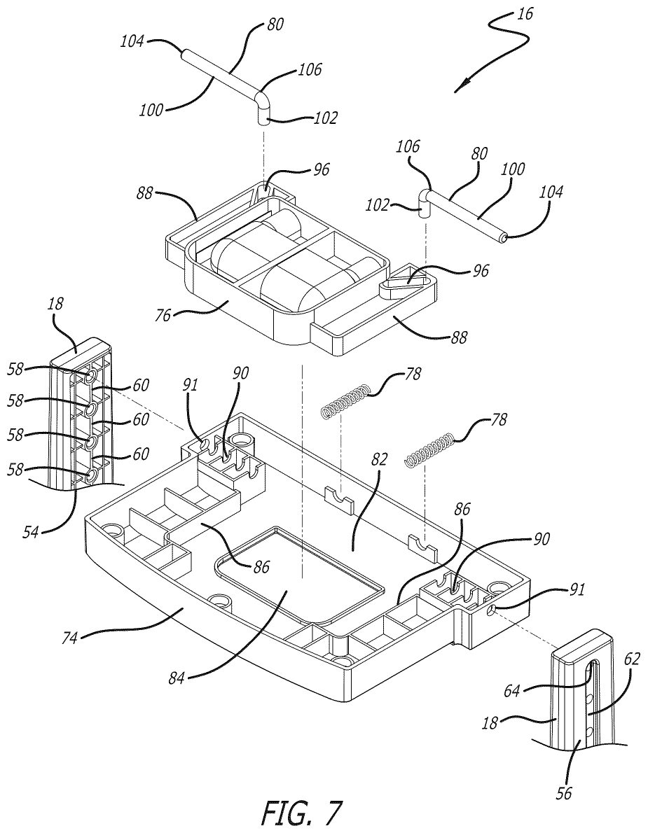

As best shown in FIGS. 7 and 8, in one embodiment the legs 18 extend upwardly from the base 12 and support the basket 14 on the base 12. The legs 18 have an interior side 54 and an exterior side 56. In one embodiment, the interior side 54 of each leg 18 includes a plurality of openings 58 and a guide 60 between the openings 58. In one embodiment the guide 60 is a surface between the openings 58, and in an alternate embodiment the guide 60 is a rib between the openings 58. Further, in one embodiment, the exterior side 56 of one or more of the legs 18 includes a recess 62 to receive a follower 64 of the basket 14. And, in one embodiment, one of more of the legs 18 has a stop 66, such as at the top 68 of the leg 18 or the top of the recess 62, that operates in conjunction with an internal protrusion 70 of the basket 14 to prevent the basket 14 from being lifted off the base 12 when the basket 14 is fully telescoped up on the legs 18.

The latching mechanism 16 is used to assist in securing the basket 14 to the legs 18 in a variety of vertical positions about the legs 18 corresponding to the plurality of openings 58 on the interior side 54 of each leg 18. In one embodiment, as shown in FIGS. 7-19, the latching mechanism 16 is secured to the basket 14, and in a preferred embodiment the latching mechanism 16 is secured to the basket 14 adjacent the bottom 52 of the basket 14. In one embodiment, the latching mechanism 16 comprises a housing 74, an activator 76, bias members 78, and latching pins 80.

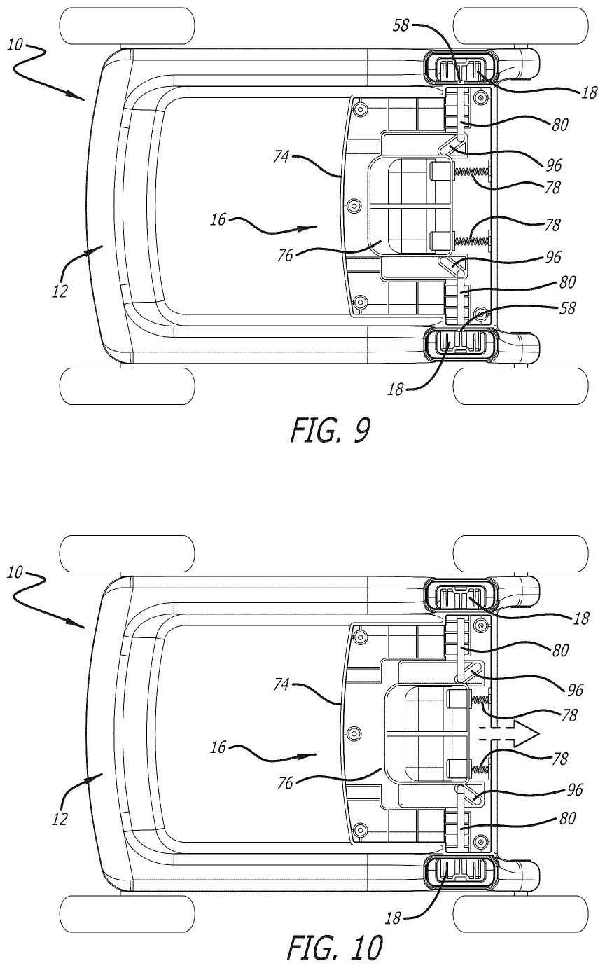

In one embodiment, the housing 74 is secured to the bottom 52 of the basket 14 with fasteners, and the activator 76 is positioned within a cavity 82 of the housing 74 and sandwiched between the bottom 52 of the basket 14 and an interior of the housing 74. The housing 74 also has an opening 84 that provides access to a portion of the activator 76 for activation by a user. As shown in FIGS. 7 and 9-10, the cavity 82 of the housing 74 has activator guides 86 to ensure that the activator 76 moves properly between its normal position and its biased position. Similarly, the activator 76 has followers 88 that engage the activator guides 86 of the housing 74 during movement of the activator 76. Further, the housing 74 has pin guides 90 to assist in properly seating and retaining the latching pins 80 in the proper location. And, the housing 74 has openings 91 through which the latching pins 80 extend as shown in FIGS. 7 and 9.

As shown in FIGS. 7-10, the activator 76 has an outer surface 92 with an activator handle 94. The activator also has slots 96 for the latching pins 80. In one embodiment, the slots 96 are provided at an angle.

The latching pins 80 operate to engage the respective openings 58 to secure the basket 14 in a locked position with respect to the legs 18 until the activator 76 is activated by a user. In one embodiment the latching pins 80 have a shaft portion 100 and a cam portion 102. In one embodiment the latching pins 80 are shaped like an “L”, such that the shaft portion 100 extends horizontally within the pin guides 90. The shaft portions 100 have a first end 104 and a second end 106. The first end 104 of the latching pins 80 is the portion that extends out of the openings 92 in the housing 74 to engage the openings 58 in the legs 18 of the base 12. The cam portion 102 extends transversely from the second end 106 of the shaft portion 100, and preferably at approximately 90° to the shaft portion 100. In one embodiment, the cam portion 102 of the latching pins 80 extends within the angled slots 96 of the activator 76, and the shaft portion 100 of the latching pins 80 translates laterally within the respective pin guides 90 as shown in FIGS. 9 and 10.

In use, the first end 104 of the latching pins 80 are positioned within the openings 58 in the legs 18 of the base 12 as shown in FIG. 9 to secure the basket 14 in a specific position with respect to the legs 18 of the base 12. To move the basket 14 up or down on the legs 18, the user engages the handle 94 of the activator 76, shown in FIG. 8, and pulls the activator 76 backwards toward the second end 40 of the basket 14 against the force of the springs 78, as shown in FIG. 10. The activator 76 moves laterally forward and backward toward the first end 36 of the basket 14 and toward the second end 40 of the basket 14, guided by the followers 88 of the activator 76 within the activator guides 86 of the housing 12. Specifically, the bias members 78 force the activator 76 toward the first end 36 of the basket 14 into its normal position as shown in FIG. 9 unless the activator 76 is actuated by a user as shown in FIG. 10 to move the activator 76 toward the second end 40 of the basket 14. As explained above, the cam portion 102 of the latching pin 80 is positioned within the angled slots 96, respectively. Due to the angle of the slots 96, when the activator 76 is pulled backward toward the second end 40 of the basket 14, the latching pins 80 will be moved laterally inwardly toward a center of the activator 76. The latching pins 80 traverse laterally within the pin guides 90 of the housing 74.

As shown in FIG. 10, when the activator 76 is pulled fully back, both of the latching pins 80 will be simultaneously removed from the openings 58 of the legs 18 and typically through the openings 91 in the housing 74. Since the latching pins 80 are no longer in the openings 58 of the legs 18, the basket 14 is free to be moved upwardly and downwardly on the legs 18 for adjusting the height of the basket 14 for different height users. When the user releases the activator 76 the bias members 78 will force the activator 76 back toward its normal position as shown in FIG. 9. However, because the legs 18 have guides 60 between the openings 58, the latching pins 80 will engage the contact the guides 60 and allow the basket 14 to move up and down between openings 58 until the first end 104 of the latching pins 80 line up with an opening 58, at which point the latching pins 80 will be biased into and seated within the respective openings 58 and fix the basket 14 in place. Different openings 58 along the leg 18 provide the basket 14 with different heights off the floor. In one embodiment there are three different openings 58 about each leg 18 for three different height settings.

The embodiments detailed hereinabove may be combined in full or in part, with any alternative embodiments described.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

Numerous modifications to the present disclosure will be apparent to those skilled in the art in view of the foregoing description. Preferred embodiments of this disclosure are described herein, including the best mode known to the inventors for carrying out the disclosure. It should be understood that the illustrated embodiments are exemplary only, and should not be taken as limiting the scope of the disclosure.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim clement is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

It will be understood that the present disclosure may be embodied in other specific forms without departing from the spirit or central characteristics thereof. The present examples and embodiments, therefore, are to be considered in all respects as illustrative and not restrictive, and the Claims are not to be limited to the details given herein. Accordingly, while the specific embodiments have been illustrated and described, numerous modifications come to mind without significantly departing from the spirit of the disclosure and the scope of protection is only limited by the scope of the accompanying Claims.

Further, the claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A shopping cart comprising:
a base having a plurality of wheels and a plurality of legs extending upwardly, the legs having a plurality of openings about a length of each leg;
a basket having a front wall, a plurality of side walls, a rear wall, and a bottom wall to define a cavity, the cavity being adjacent a first end of the basket for supporting items place within the cavity of the basket, the basket having a second end opposite the first end, the basket further having a plurality of receivers at a bottom of the basket for receiving the legs of the base; and,
a latching mechanism to secure the basket to the base, the latching mechanism being connected to the basket and comprising a housing, an activator and latching pins, the activator moving from a normal position to a biased position and having angled slots to adjust the latching pins to allow the basket to traverse up and down on the legs, the latching pins engaging the openings in the legs when the activator is in the normal positon to secure the basket at a variety of positions about the legs, and the latching pins being removed from the openings in the legs when the activator is in the biased position.

2. The shopping cart of claim 1, wherein the latching pins have a shaft portion and a cam portion, wherein the cam portion of the latching pins extends within the angled slots of the activator, and wherein the shaft portion of the latching pins translates laterally to be positioned within the openings in the legs of the base.

3. The shopping cart of claim 1, wherein the receivers are provided adjacent the second end of the basket.

4. The shopping cart of claim 1, wherein the legs have an interior side and an exterior side, and wherein the openings are on the interior side of the legs.

5. The shopping cart of claim 4, wherein the exterior side of one or more of the legs includes a recess to receive a follower of the basket.

6. The shopping cart of claim 5, wherein one of more of the legs has a stop that operates in cooperation with an internal protrusion of the basket to prevent the basket from being lifted off the base when the basket is fully telescoped up on the legs.

7. The shopping cart of claim 1, wherein the basket also has a handle for pushing the shopping cart, the handle being provided adjacent the second end of the basket.

8. The shopping cart of claim 1, wherein the latching mechanism further comprises a bias member to force the activator from its biased position to its normal position.

9. The shopping cart of claim 1, further comprising a product separator adjacent the second end of the basket.

10. The shopping cart of claim 9, wherein the product separator comprises plurality of different shaped openings.

11. The shopping cart of claim 1, further comprising a product sensor adjacent the second end of the basket.

12. The shopping cart of claim 11, further comprising a controller and a speaker in electrical communication with the product sensor.

13. A shopping cart comprising:
a base having a plurality of wheels and a leg extending upwardly, the leg having openings about a length thereof;
a basket having a cavity for supporting items therein, a receiver for receiving the leg of the base, and a handle for pushing the shopping cart, the handle being provided adjacent a second end of the basket; and,
a latching mechanism to secure the basket to the base, the latching mechanism being connected to the basket and comprising an activator, a bias member, and a latching pin, the activator moving from a normal position to a biased position, the bias member biasing the activator from its biased position to its normal position, the latching pin moving from an engaged position when the activator is in the normal position, to a disengaged position when the activator is in the biased position, the latching pin engaging one of the openings in the leg when the activator is in the normal positon, and the latching pin being removed from the openings in the leg when the activator is in the biased position to secure the basket at a variety of positions about the leg.

14. The shopping cart of claim 13, wherein the latching mechanism is secured to a bottom of the basket.

15. The shopping cart of claim 13, wherein the activator has a handle for a user to move the activator to the biased position.

16. The shopping cart of claim 13, wherein the activator has angled slots to adjust the latching pins to allow the basket to traverse up and down on the legs.

17. The shopping cart of claim 16, wherein the latching pins have a shaft portion and a cam portion, wherein the cam portion of the latching pins extends within the angled slots of the activator, and wherein the shaft portion of the latching pins translates laterally to be positioned within the openings in the legs of the base.

18. A shopping cart, comprising:
a base having a plurality of wheels and a plurality of legs extending upwardly, the legs having a plurality of openings about a length of each leg;
a basket having a cavity for supporting items therein, a plurality of receivers adjacent a second end of the basket for receiving the legs of the base, and a handle for pushing the shopping cart, the handle being provided adjacent the second end of the basket; and,
a latching mechanism to secure the basket to the base, the latching mechanism being connected to the basket and comprising an activator, a bias member, and latching pins, the activator moving from a normal position to a biased position, the bias member biasing the activator from its biased position to its normal position, the latching pins moving from an engaged position when the activator is in the normal position, to a disengaged position when the activator is in the biased position, the latching pins engaging openings in the legs when the activator is in the normal positon, and the latching pins being removed from the openings in the legs when the activator is in the biased position to secure the basket at a variety of positions about the legs.

19. The shopping cart of claim 18, wherein the activator has angled slots to adjust the latching pins to allow the basket to traverse up and down on the legs.

20. The shopping cart of claim 19, wherein the latching pins have a shaft portion and a cam portion, wherein the cam portion of the latching pins extends within the angled slots of the activator, and wherein the shaft portion of the latching pins translates laterally to be positioned within the openings in the legs of the base.
